(19) United States
(12) Patent Application Publication
(10) Pub. No.: US 2011/0055023 A1
(43) Pub. Date: Mar. 3, 2011

(54) ABOVE THE FOLD

(75) Inventors: Michael MCNEELEY, Burbank, CA (US); Matt MLINAC, San Francisco, CA (US)

(73) Assignee: YAHOO! INC., Sunnyvale, CA (US)

(21) Appl. No.: 12/550,339

(22) Filed: Aug. 28, 2009

(51) Int. Cl. G06Q 30/00; G06F 3/00

(52) U.S. Cl. 705/14.72; 705/14.73; 715/760

(57) ABSTRACT

A computer-implementable method for determining an advertisement position is provided. The method includes receiving, at a server, a user request, via a computer client, for displaying a webpage in a window of a browser of the client computer, where the webpage includes at least one ad. Further, the method includes receiving viewport information from the browser. Based on the viewport information, viewable canvas information is calculated. The viewable canvas information is related to a displayable portion of the webpage. The method further includes generating ad position information based on the viewable canvas information. In embodiments, the ad position information is for determining fees related to advertising on the webpage.

### BACKGROUND OF THE INVENTION

Traditionally, television, radio, newspapers, and magazines are viewed as effective media for advertising. Recently, advertising over more interactive media has become popular. For example, with the increased use and popularity of the Internet, advertisers have increased focus on online advertising.

Advertising on webpages presents a set of new challenges than advertising on other types of media. For example, determining the typical users that view the webpage, the users' interests, and the ad placement that will likely be viewed by the intended audience are important factors for determining price ad space on webpages. Generally, the price for ad space that will reach a high number of users will be sold to advertisers at a higher price. Often, the ad placement will direct sales price and negotiation.

However, predicting the likelihood a user will see the advertisement is a challenging task. Users view webpages in browsers. Thus, one user's browser may be of a different size or be set to display the webpage differently than a second user. Therefore, there may be a challenge in predicting the actual views of a webpage by users since an advertisement may not be seen by a user, depending on the size of the browser. Thus, as an example, many contracts between advertisers and Web publishers require ads to be “above the fold” or on the screen seen by users with computers set to standard screen sizes (e.g. 640×690 or 800×600, etc). Accordingly, ad systems for large publishers typically define advertiser “channels,” such as (1) high price “above the fold” inventory, or (2) lower price “run of site” inventory. The “run of site” inventory may be “below the fold” or on webpages where the user is likely not to interact with an ad (e.g., a Website login page).

To solve this problem, some ad space providers sell ads on a price-per-click basis. Unfortunately, price-per-click advertising is not always effective and not useful for advertisers that doe not require a click on their ad.

As such, methods and systems for a more accurate determination of potential viewers of an ad are desired.

### BRIEF SUMMARY OF THE INVENTION

In accordance with embodiments of the present invention, a computer-implementable method for determining an advertisement position is provided. The method includes receiving, at a server, a user request, via a computer client, for displaying a webpage in a window of a browser of the client computer, where the webpage includes at least one ad. Further, the method includes receiving viewport information from the browser. Based on the viewport information, viewable canvas information is calculated. The viewable canvas information is related to a displayable portion of the webpage. The method further includes generating ad position information based on the viewable canvas information. In embodiments, the ad position information is for determining fees related to advertising on the webpage.

Further, in accordance with embodiments of the invention, a computer-readable medium encoded with executable instructions for generating ad position information is provided. The instructions comprise instructions for receiving a user request for displaying a webpage in a window of a browser, the webpage including at least one ad, receiving viewport information from the browser, and calculating viewable canvas information based on the viewport information. The viewable canvas information is related to a displayable portion of the webpage. The instructions further comprise instructions for generating ad position information based on the viewable canvas information.

In accordance with embodiments of the invention, a system for generating ad position information is provided. The apparatus comprises a processor, and a memory for storing computer instructions executable by the processor. The stored instructions comprise instructions for receiving a user request for displaying a webpage in a window of a browser, the webpage including at least one ad, receiving viewport information from the browser, and calculating viewable canvas information based on the viewport information. The viewable canvas information is related to a displayable portion of the webpage. The stored instructions further include instructions for generating ad position information based on the viewable canvas information.

Other features and aspects of the invention will become apparent from the following detailed description, taken in conjunction with the accompanying drawings which illustrate, by way of example, the features in accordance with embodiments of the invention. The summary is not intended to limit the scope of the invention.

### BRIEF DESCRIPTION OF THE DRAWINGS

FIG. 1 illustrates a flowchart of a computer-implementable method for determining ad viewability according to embodiments of the invention;

FIG. 2 illustrates a browser displaying a webpage including an ad according to embodiments of the invention;

FIG. 3 illustrates a browser displaying a webpage including an ad according to embodiments of the invention;

FIG. 4 illustrates a browser displaying a webpage including an ad according to embodiments of the invention;

FIG. 5 illustrates a system for determining ad viewability according to embodiments of the invention;

FIG. 6 illustrates a webpage where ad space has been priced based on ad viewability according to embodiments of the invention;

FIG. 7 illustrates an ad loading into a webpage according to embodiments of the invention; and

FIG. 8 illustrates a block diagram of a computing system according to embodiments of the invention.

In the following description, reference is made to the accompanying drawings which form a part thereof, and which illustrate several embodiments of the present invention. It is understood that other embodiments may be utilized and structural and operational changes may be made without departing from the scope of the present invention. The use of the same reference symbols in different drawings indicates similar or identical items.

### DETAILED DESCRIPTION OF THE INVENTION

The following description is presented to enable any person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown.

A webpage may span beyond the viewable area. As such, some of its contents can only be viewed by scrolling. Items that are fully displayed without scrolling are in an above the fold position. Items that are partially displayed in the viewable area may be described as spanning the fold. Items that are not displayed in the viewable area may be described as below the fold.

Embodiments of the invention allow an ad server to record and track the frequency a particular ad is served above the fold, below the fold, or spanning the fold, for example. This information may be used by advertisers to give a better indication of users actually viewing the ad. Accordingly, some advertiser may be able to adjust pricing or control ad viewability, for example.

Embodiments of the invention may allow advertisers to require, or prefer, specific positioning of their ads when purchasing ad space. The ad server may serve ads targeted for positions required by the advertisers.

In embodiments, there may not be a required or preferred position associated with an ad, but still served by the ad server to available positions.

Embodiments of the invention may allow for an ad server to track the position of placement of a served ad to charge advertisers for serving the ad. For example, an advertiser may pay a base price for an ad to be served anywhere on a webpage. Additionally, the advertiser may pay an additional price for their ad to be served in a premium position, such as above the fold.

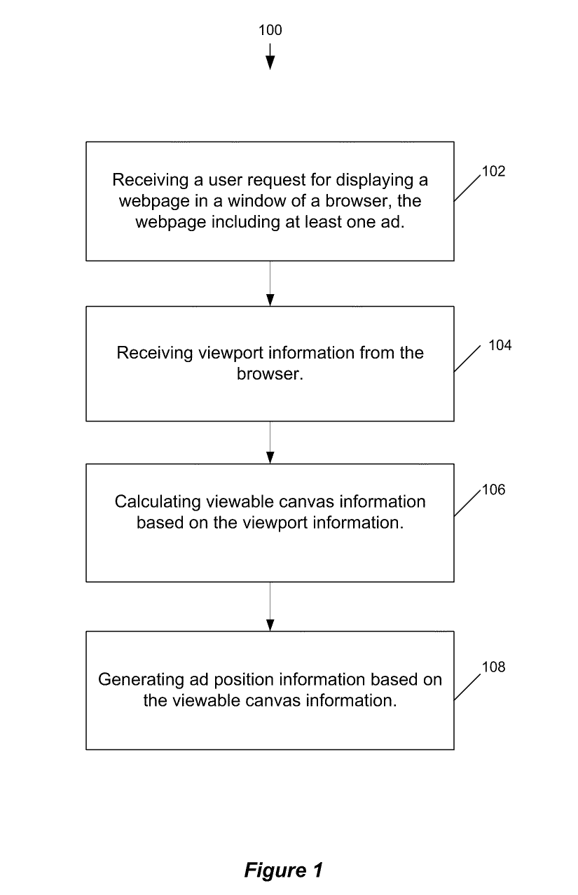

FIG. 1 illustrates a flowchart of a computer-implementable method for determining ad viewability according to embodiments of the invention. Client computer have browsers applications that allow users of the client computers to view webpages over the Internet. A user requests a webpage to be displayed in the browser of the client computer in 102. Viewport information is received from the browser in 104.

The viewport information relate to browser settings, such as height and width of the area viewable by the user. The viewport information may also relate to the scroll bar position, which indicates the offset position of the webpage that is displayed within the browser. As such, changes in the viewport of the browser may trigger viewport information to be received again.

The received viewport information is used to calculate a viewable canvas information in 106. Viewable canvas information is related to the displayable portion of the webpage in the browser. From the viewable canvas information, an ad position is generated in 108. The ad position may be characterized as above the fold, below the fold, or in the fold, for example. When a element of a webpage, such as an ad, is entirely viewable in the browser, this is described as above the fold. In other cases, the element in the webpage may not entirely be viewed in the browser since it spans beyond the viewable area of the browser. If a portion of a webpage element is viewable, this is said to be in the fold. Furthermore, if the webpage element is not displayed in the viewable area of the browser, then it is said to be below the fold.

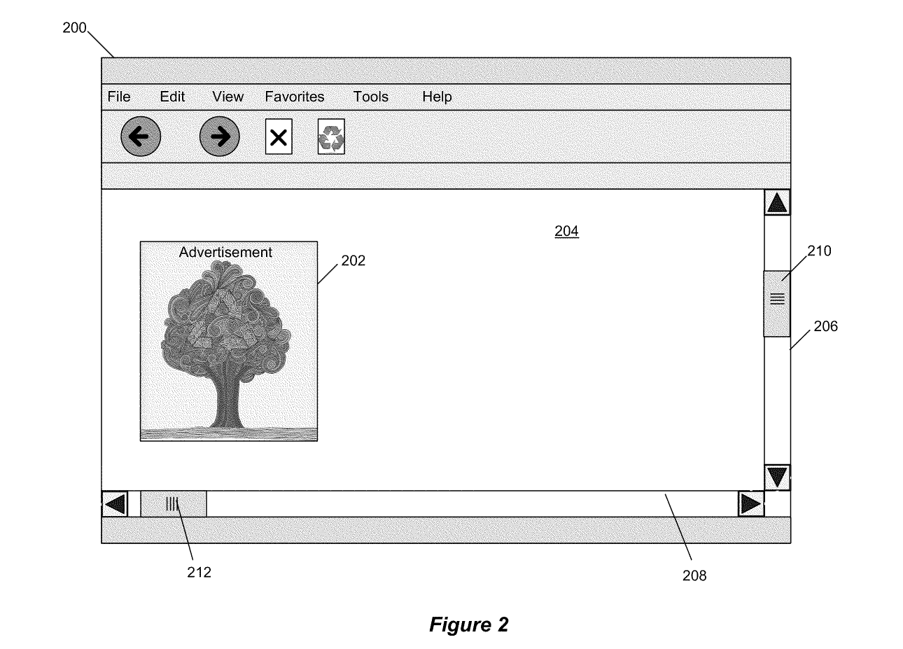

An embodiment of a browser displaying a webpage according to embodiments of the invention is illustrated in FIG. 2, for example. A user at a client computer may request a webpage over the Internet. A browser 200 is illustrated displaying the webpage 204. The browser 200 includes a vertical scroll bar 206 with a slide 210. A user may use the slide 210 to change the vertical position of the displayed webpage 202. The browser 200 also includes a horizontal scroll bar 208 with slide 212. Similarly, a user may use slide 212 to adjust the horizontal position of the displayed webpage 204.

Included in the webpage 204 is an ad 202. As illustrated in this embodiment the browser 200 allows a user to view the entire ad 202. The size of the ad 202 allows for the entire ad to be displayed in accordance with the settings of the browser 200.

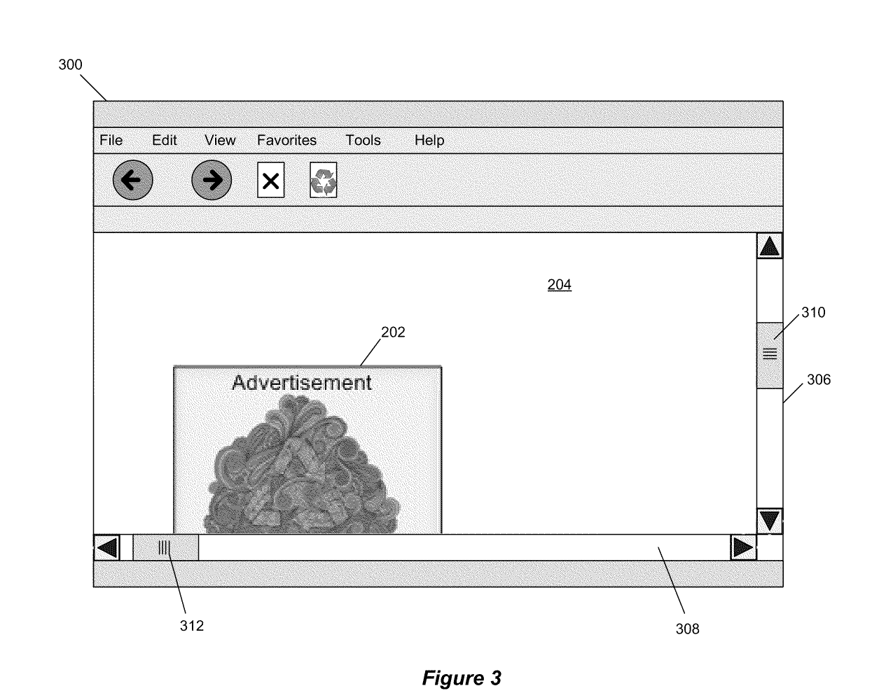

In contrast to FIG. 2, FIG. 3 illustrates another browser 300 displaying the webpage 204 including an ad according to embodiments of the invention. However, in the browser settings of browser 300 differ from browser 200, such that the ad 202 cannot be entirely displayed in the viewable area of the browser 300, although it is the same webpage 204 that is illustrated in FIG. 2. The viewport, or displayable area of the browser, may have a different height or width, for example, which would affect the viewport.

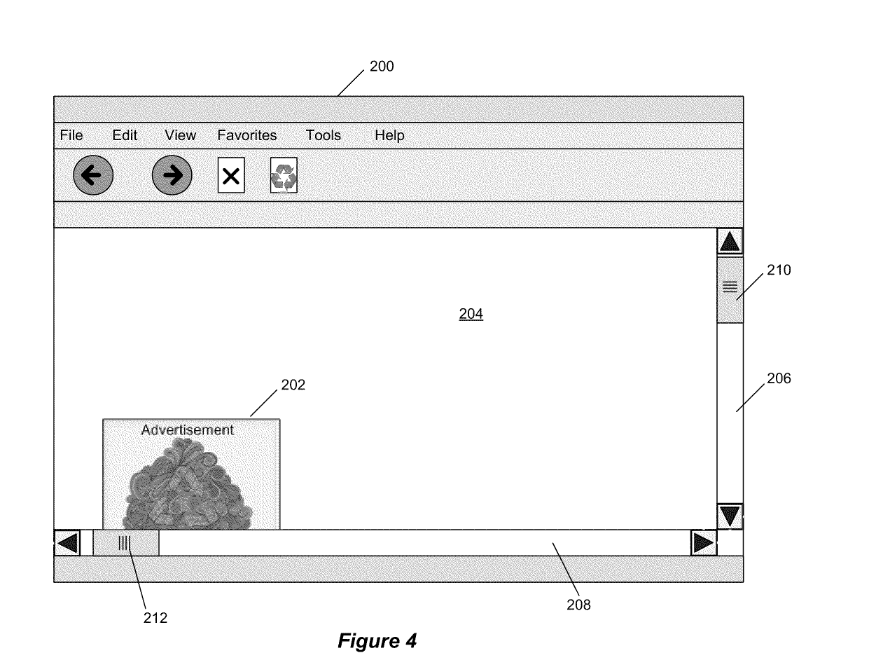

Other embodiments of a browser are illustrated in FIG. 4. The browser 200, as illustrated in FIG. 2, displays webpage 204, including ad 202. The browser includes a vertical scrollbar 206 and corresponding slide 210. Further, the browser includes a horizontal scrollbar 208 and corresponding slide 212. The slide 210 has been adjusted such that the vertical position of the displayed webpage 204 has been adjusted accordingly. Thus, the ad 202 is not entirely visible. The ad may be described as in the fold. After such a scroll adjustment is made, for example, the browser 200 will have updated viewport information.

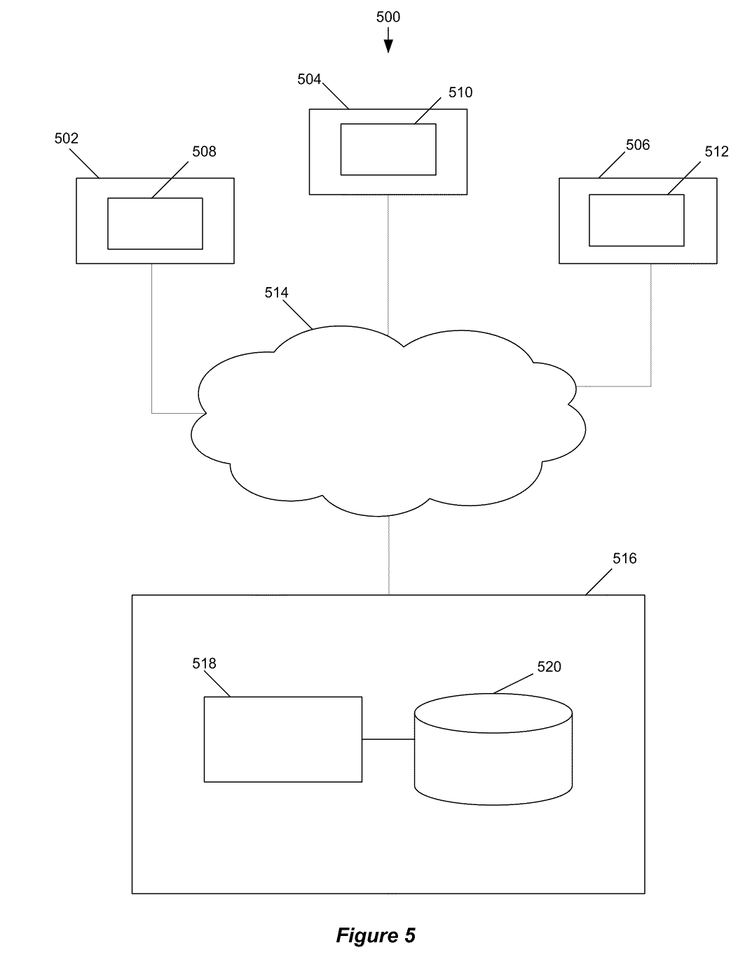

FIG. 5 illustrates a system for determining ad viewability according to embodiments of the invention. System 500 illustrates client computers 502, 504, 506, with respective browsers 508, 510, and 512, capable of communication over a network 514 to server 516. A plurality of client computers may be able to communicate over network 514 to server 516.

As an example, a user at client computer 502 may request a webpage to be displayed. The requested webpage may include at least one ad. In response, the browser will send viewport information to the server 516, such that it can be determined what portion of the webpage will be visible in the browser 508. Viewport information relates to the settings of the browser, such as dimensions. Processor 518 of server 516 calculates viewable canvas information based on the viewport information. Viewable canvas information relates to the displayable portion or the webpage in the browser.

For example, the viewable canvas can be determined by the vertical scroll position of the browser and adding it to the height of the browser viewport. The browser viewport is the viewable area within the browser window. Both of these are native to the browser and accessible via the browser in JavaScript.

Thus, an ad viewed on one browser may not be viewed on another browser that may have different settings, for example. Accordingly, viewabilty of an ad may be different depending on the browser settings of each user.

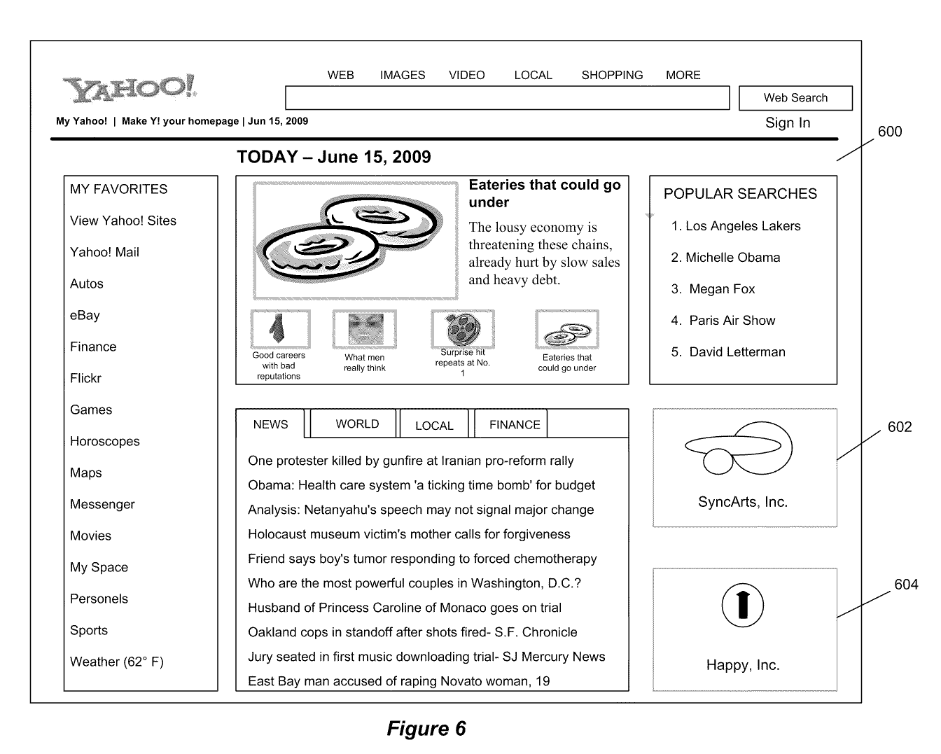

Illustrated in FIG. 6 is an example of a whole webpage 600, which may be requested by a user. The portion of the webpage that is displayed to the user may be different to different users. For example, the browser of user A may display both ad 602 and ad 604. However, the browser of user B may only display ad 602 and not ad 604. Alternatively, ad 604 may only be partially displayed in the browser of user B.

As another example, after user A requests webpage 600, webpage 600 is loaded into the browser of user A and ad 602 is fully displayed. User A may then scroll down his browser and ad 604 is displayed as user A scrolls down so that ad 604 is above the fold.

In these examples, the number of times ad 604 is above the fold (fully displayed to the user) or in the fold (partially displayed) may vary compared with ad 602. Statistics including ad position and click rate, for example, may be accumulated and stored. In this way, ad space can be sold to advertisers based on the viewability of the ad space, according to embodiments of the invention.

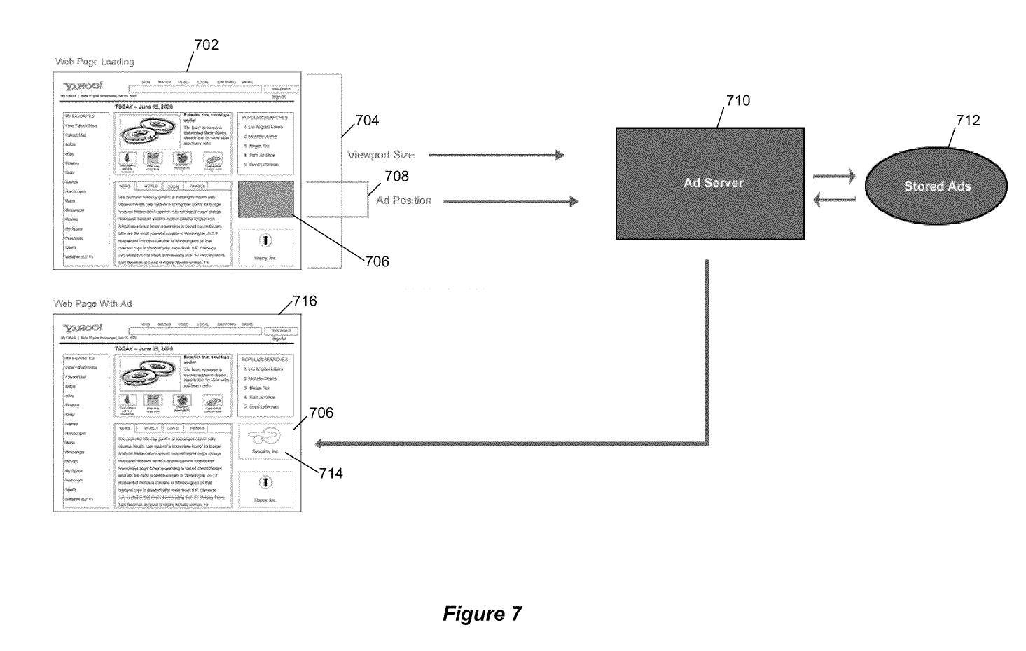

FIG. 7 illustrates an ad loading into a webpage according to embodiments of the invention. After a user requests webpage to be displayed in the user's browser, it is determined the loading webpage 702 needs more information about the ads. For example, an ad may be loaded into ad space 706. Accordingly, an ad call is made to an ad server 710. The browser sends information such as viewport size 704 and ad position 708 to the ad server 710, for example. In response to the ad call, the ad server 710 selects the ads from the stored ads. The ads are stored in a storage medium connected to the ad server 710.

The ads are selected based on requirements such as position. For example, based on the viewport size and ad position, the ad server 710 may determine viewable canvas information. That is, the ad server 710 may determine whether the ad loaded into ad space 706 will be above the fold, spanning the fold, or below the fold. In other words, based on the browser and scroll position, the ad space 706 may be fully displayed in the user's browser, partially displayed in the user's browser, or not displayed in the browser until the scroll position is adjusted.

The stored ads may be associated with position criteria. For example, the advertiser may require the ad be served only if it is above the fold. Thus, if it is determined the ad space 706 will not be above the fold, the ad designated as to be served if above the fold will not be loaded into ad space 706 by the ad server. Alternatively, some ads may have multiple position requirements, such as above the fold and spanning the fold. Some ads may not have any position criteria. Based on the determination of the position of ad space 706 and the associated requirements of the stored ads 712, the stored ads are filtered and an eligible set of ads is returned to the server.

The selected ad 714 determined by ad server 710 is served to the user's browser and loaded into the ad space 706. An ad-loaded webpage 716 is displayed in the user's browser.

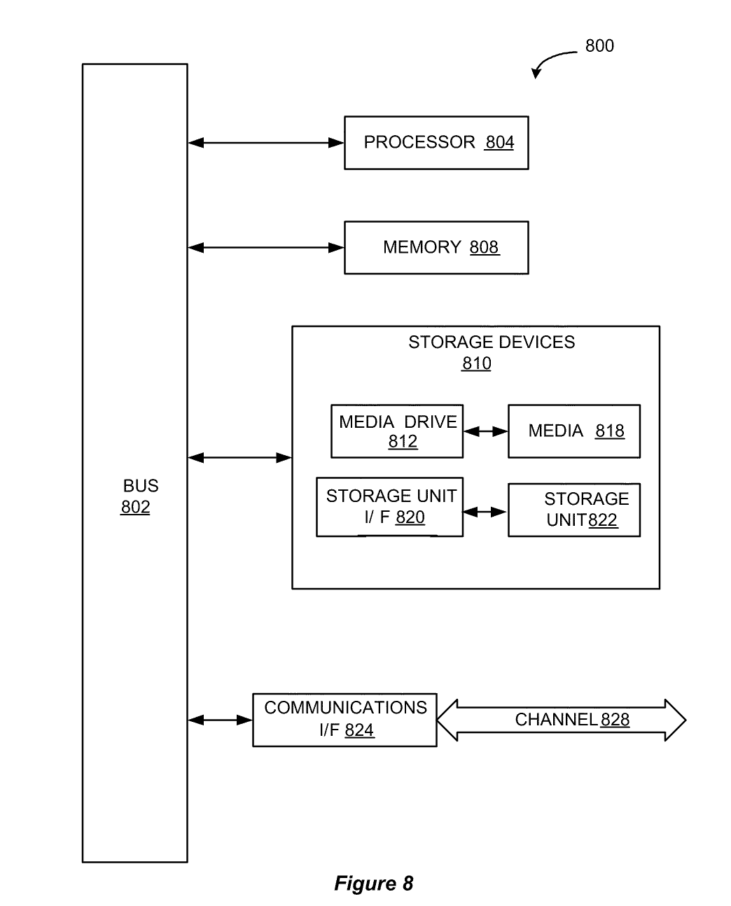

FIG. 8 illustrates a block diagram of a computing system according to embodiments of the invention. While aspects of the invention, including the above described systems and methods, are described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic, and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

FIG. 8 illustrates an exemplary computing system 800 that may be employed to implement processing functionality for various aspects of the invention (e.g., as a server device, client device, database, presence platform, combinations thereof, and so on). Those skilled in the relevant art will also recognize how to implement the invention using other computer systems or architectures. Computing system 800 may represent, for example, a desktop, mainframe, server, client, or any other type of special or general purpose computing device as may be desirable or appropriate for a given application or environment. Computing system 800 can include one or more processors, such as a processor 804. Processor 804 can be implemented using a general or special purpose processing engine such as, for example, a microprocessor, microcontroller or other control logic. In this example, processor 804 is connected to a bus 802 or other communication medium.

Computing system 800 can also include a main memory 808, for example random access memory (RAM) or other dynamic memory, for storing information and instructions to be executed by processor 804. Main memory 808 also may be used for storing temporary variables or other intermediate information during execution of instructions to be executed by processor 804. Computing system 800 may likewise include a read only memory (“ROM”) or other static storage device coupled to bus 802 for storing static information and instructions for processor 804.

The computing system 800 may also include information storage mechanism 810, which may include, for example, a media drive 812 and a removable storage interface 820. The media drive 812 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 818 may include, for example, a hard disk, floppy disk, magnetic tape, optical disk, CD or DVD, or other fixed or removable medium that is read by and written to by media drive 814. As these examples illustrate, the storage media 818 may include a computer-readable storage medium having stored therein particular computer software or data.

In alternative embodiments, information storage mechanism 810 may include other similar instrumentalities for allowing computer programs or other instructions or data to be loaded into computing system 800. Such instrumentalities may include, for example, a removable storage unit 822 and an interface 820, such as a program cartridge and cartridge interface, a removable memory (for example, a flash memory or other removable memory module) and memory slot, and other removable storage units 822 and interfaces 820 that allow software and data to be transferred from the removable storage unit 818 to computing system 800.

Computing system 800 can also include a communications interface 824. Communications interface 824 can be used to allow software and data to be transferred between computing system 800 and external devices. Examples of communications interface 824 can include a modem, a network interface (such as an Ethernet or other NIC card), a communications port (such as for example, a USB port), a PCMCIA slot and card, etc. Communications interface 824 is capable of receiving electromagnetic, optical, or other signals. These signals are provided to communications interface 824 via a channel 828. This channel 828 may carry instructions and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 808, storage device 818, storage unit 822, or signal(s) on channel 828. These and other forms of computer-readable media may be involved in providing one or more sequences of one or more instructions to processor 804 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into computing system 800 using, for example, removable storage drive 814, drive 812 or communications interface 824. The control logic (in this example, software instructions or computer program code), when executed by the processor 804, causes the processor 804 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention. Moreover, aspects of the invention describe in connection with an embodiment may stand alone as an invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A computer-implemented method for determining an advertisement position, the method comprising:
receiving, at a server, a user request, via a client computer, for displaying a webpage in a window of a browser of the client computer, the webpage including at least one ad;
receiving, at the server, viewport information from the browser;
calculating, at the server, viewable canvas information based on the viewport information, wherein the viewable canvas information is related to a displayable portion of the webpage; and
generating, at the server, ad position information based on the viewable canvas information.

2. The method of claim 1, wherein the viewport information includes dimensions of the browser.

3. The method of claim 1, wherein the viewport information includes scroll position.

4. The method of claim 1, further comprising:
receiving updated viewport information from the browser.

5. The method of claim 1, wherein the updated viewport information is received after a scroll reset.

6. The method of claim 1, wherein the updated viewport information is received after a window reset.

7. The method of claim 4, further comprising:
calculating updated viewable canvas information based on the updated viewport information; and
generating updated ad position information based on the updated viewable canvas information.

8. The method of claim 1, wherein the ad position information indicates if the ad included in the displayed webpage is viewable.

9. The method of claim 8, wherein the ad position information indicates the portion of the ad that is viewable.

10. The method of claim 1, wherein the ad position information indicates one of a group of ad positions consisting of: above the fold position, below the fold position, and in the fold.

11. The method of claim 1, wherein the ad position information is for determining fees related to advertising on the webpage.

12. A computer-readable medium encoded with executable instructions for generating ad position information, the instructions comprising instructions for:
receiving a user request for displaying a webpage in a window of a browser, the webpage including at least one ad;
receiving viewport information from the browser;
calculating viewable canvas information based on the viewport information, wherein the viewable canvas information is related to a displayable portion of the webpage; and
generating ad position information based on the viewable canvas information.

13. The computer-readable medium of claim 12, wherein the viewport information includes dimensions of the browser.

14. The computer-readable medium of claim 12, wherein the viewport information includes scroll position.

15. The computer-readable medium of claim 12, wherein the instructions further comprise instructions for:
receiving updated viewport information from the browser.

16. The computer-readable medium of claim 15, wherein the instructions further comprise instructions for:
calculating updated viewable canvas information based on the updated viewport information; and
generating updated ad position information based on the updated viewable canvas information.

17. The computer-readable medium of claim 15, wherein the ad position information indicates one of a group of ad positions consisting of: above the fold position, below the fold position, and in the fold.

18. The computer-readable medium of claim 15, wherein the ad position information is for determining fees related to advertising on the webpage.

19. A system for generating ad position information, the apparatus comprising:
a processor; and
a memory for storing computer instructions executable by the processor, the instructions for:
receiving a user request for displaying a webpage in a window of a browser, the webpage including at least one ad;
receiving viewport information from the browser;
calculating, by the processor, viewable canvas information based on the viewport information, wherein the viewable canvas information is related to a displayable portion of the webpage; and
generating ad position information, by the processor, based on the viewable canvas information.

20. The system of claim 19, wherein the instructions are further for:
receiving updated viewport information from the browser.

21. The system of claim 19, wherein the updated viewport information is received after a scroll reset.

22. The system of claim 20, wherein the instructions further for:
calculating updated viewable canvas information based on the updated viewport information; and
generating updated ad position information based on the updated viewable canvas information.

23. The system of claim 19, wherein the ad position information indicates one of a group of ad positions consisting of: above the fold position, below the fold position, and in the fold.

24. The system of claim 19, wherein the ad position information is for determining fees related to advertising on the webpage.
